(19) United States
(12) Patent Application Publication
(10) Pub. No.: US 2014/0211234 A1
(43) Pub. Date: Jul. 31, 2014

(54) SYSTEMS AND METHOD FOR PRINTING OVER A NETWORK

(71) Applicant: Hewlett-Packard Development Company, L.P., Houston, TX (US)

(72) Inventor: Vaibhav Malik, Bangalore (IN)

(73) Assignee: Hewlett-Packard Development Company, L.P., Houston, TX (US)

(21) Appl. No.: 13/899,650

(22) Filed: May 22, 2013

(30) Foreign Application Priority Data
Jan. 28, 2013 (IN) 222/DE3/2013

(51) Int. Cl. G06F 3/12; H04N 1/44

(52) U.S. Cl. CPC G06F 3/1296; H04N 1/4413
USPC 358/1.14; 358/1.15

(57) ABSTRACT

Systems and methods for printing a document over a network are described. In one implementation, the printing system (102) comprises a processor (104); and a printer console (114) coupled to the processor(104). The printing console (114) receives a print job from a user, the print job comprising a unique resource identifier (URI) of a document which is to be printed and print parameters associated with the print job. The printing system (102) also comprises a web access module (118) coupled to the processor(104), to download the document over the network and a printer unit (122) coupled to the processor(104), to print the document based on the print parameters.

### BACKGROUND

A printer is usually connected to computing system either directly or over a communication network, such as a local area network (LAN) or a wide area network (WAN). Different kinds of printers are commercially available, such as inkjet printers and laser printers. Many commercially available printers also include other components which facilitate additional functionalities, such as scanning, copying, and faxing.

Typically, to print a document, a user selects a print command from an application program running on a host system to initiate print services. The print services generate a user interface in the form of a print dialog box that allows the user to select various print options, such as source of media, number of copies of the document, page orientation, print quality and pages per sheet of the media. After the user selects the print options and commences the print operation, a printer driver converts the document to a PDL (page description language) format that corresponds to the model of the printer selected by the user. The printer driver then transmits the PDL to the printer where it is rendered as a hardcopy.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the figures to reference like features and components:

FIG. 1a schematically illustrates the components of a printing system, according to an example of the present subject matter.

FIG. 1b schematically illustrates the components of a printing system in a cloud environment, according to an example of the present subject matter.

FIG. 2 illustrates a method for printing a document over a network, according to an example of the present subject matter.

FIG. 3 illustrates a method for printing a document in a cloud environment, according to an example of the present subject matter.

FIG. 4 illustrates a method for printing a document in a cloud environment, according to another example of the present subject matter.

### DETAILED DESCRIPTION

The present subject matter relates to systems and methods for printing a document over a network. The methods and systems as described herein may be implemented as any web enabled printer, which can access the internet over a communication network. The web enabled printer may be a inkjet printer, a laser printer, a large format printer, and a multi function printer (MFP). The MFP may be understood to be a device whose primary function is printing but which provides other functionalities such as photocopying, scanning, and faxing a document.

Generally, printers are connected, either directly or over a communication network, to host systems, such as a laptop, a personal computer, a work station, and a print server. In many scenarios, a user may want to print a document located on the Internet. For example, the user may have booked an electronic ticket on an online ticketing portal and may wish to obtain a print copy of the same. In such a case, the user usually needs to log on to a host computer, access the document using a browser and then print the document, by using the print command of the browser. This is usually time-consuming as the user may need to boot the host system or log on to the host system for only the aforementioned purpose. Further, in many cases, the host system may not be available to the user. For example, the battery of the user's laptop may have run out and a charging point may not be available.

The systems and methods, described herein, implement printing a document over a network. In one implementation, the method of printing with multiple print settings is implemented using a printing system. The printing system may be implemented as any web enabled printer, which can access the internet over a communication network. In said implementation, the printing system includes a printer console which may be configured to generate a user interface to facilitate a user to provide instructions to the printing system.

In operation, the user may provide an indication to the printing system that he wants to print a document. The indication may be in form of pressing a button or touching an icon on the user interface generated by the printer console. On receiving the user indication, the printing system may provide the user with a user interface to enter the unique resource identifier (URI) of the document. The URI may be in form of a uniform resource locator (URL) of a webpage, a file server protocol (FTP) server address, and so on. In one example, the user may enter the URI using a keypad of the printing system. In another example, the user may write or print the URI of the document on a paper and scan the same. The printing system may use techniques, such as optical character recognition (OCR), to decipher the URI of the document from the scan.

In one example, the user may indicate that the printing of the document corresponding to the URI is a recurring job which is to be done at specified time or after specified time intervals. For example, the URI may correspond to a document which shows a current market value of stocks owned by the user. The user may like to be provided with a printout of the document every thirty minutes and may provide instructions accordingly. In another example, the URI may correspond to a document which shows flight arrival or departure schedules. The user may like to be provided with a printout of the document, say, two hours before the scheduled departure of his flight and provide instructions accordingly. In yet another scenario, the URI may correspond to a document which is an electronic ticket of the user, which the user may want to print immediately and may provide instructions accordingly.

The printing system may further prompt the user to input a claim code corresponding to the printing instructions. The claim code may be used as a password to validate the user at the time of providing the output. In one example, the claim code may be in form of an alphanumeric code, a numeric personal identification number (PIN) and the like.

On receiving the user instructions, the printing system may verify the availability of resources to execute the print job. For example, the printing system may ascertain the availability of the media on which the document is to be printed, availability of ink, connectivity to the internet and so on. On ascertaining the availability of resources, the printing system may notify the user that the print job has been accepted and will be processed. In case, the printing system ascertains at least one of the resources to be unavailable because of which the print job cannot be executed, the printing system may generate an error message and notify the user.

As per the schedule of the print job, the printing system may access and download the document identified by the URI over the internet. On successful downloading of the document, the printing system may notify the user, for example through e-mail, that the user's print job is ready for execution. The user may then be prompted to enter the claim code for verification. If the claim code matches the earlier claim code entered by the user, the printing system prints the document and the user is provided with a hard copy of the document. In case, the claim code does not match the earlier claim code entered the user, the printing system generates an error message for the user and may indicate the user to re-enter the claim code.

Thus, the printing system as described above facilitates printing of documents located on the Internet without the user having to log on to a host system for accessing the document and then printing the same. The printing system further facilitates the user to get regular or periodic updates by providing the user to print a document at specific time intervals.

The above systems and methods are further described in conjunction with the following figures. It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and examples of the present subject matter, as well as specific examples thereof, are intended to encompass equivalents thereof.

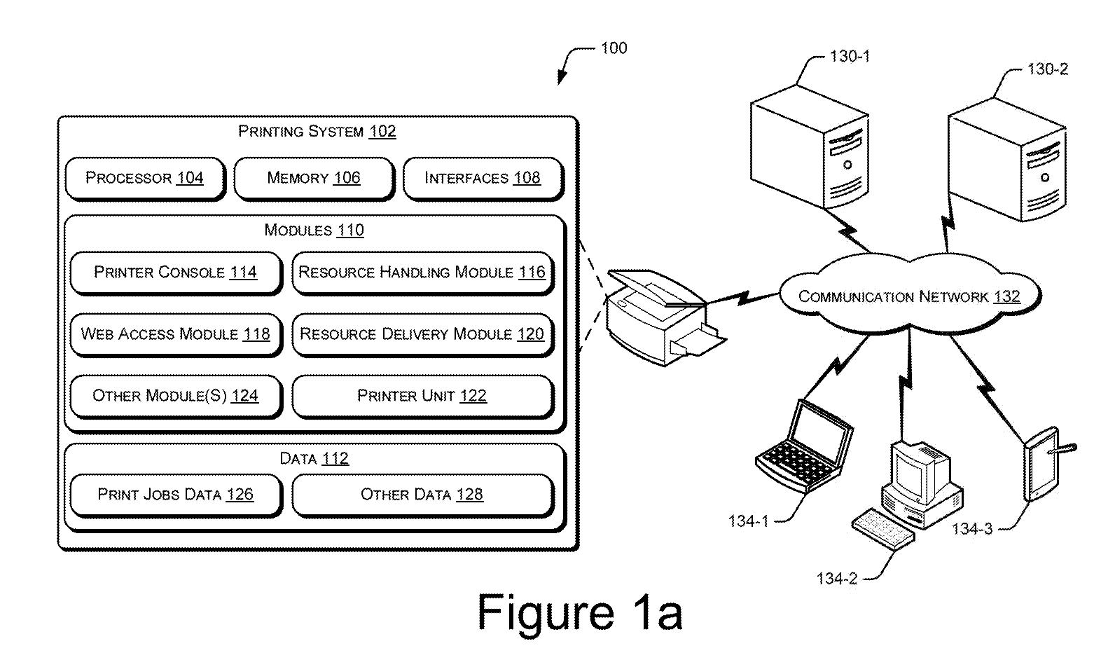

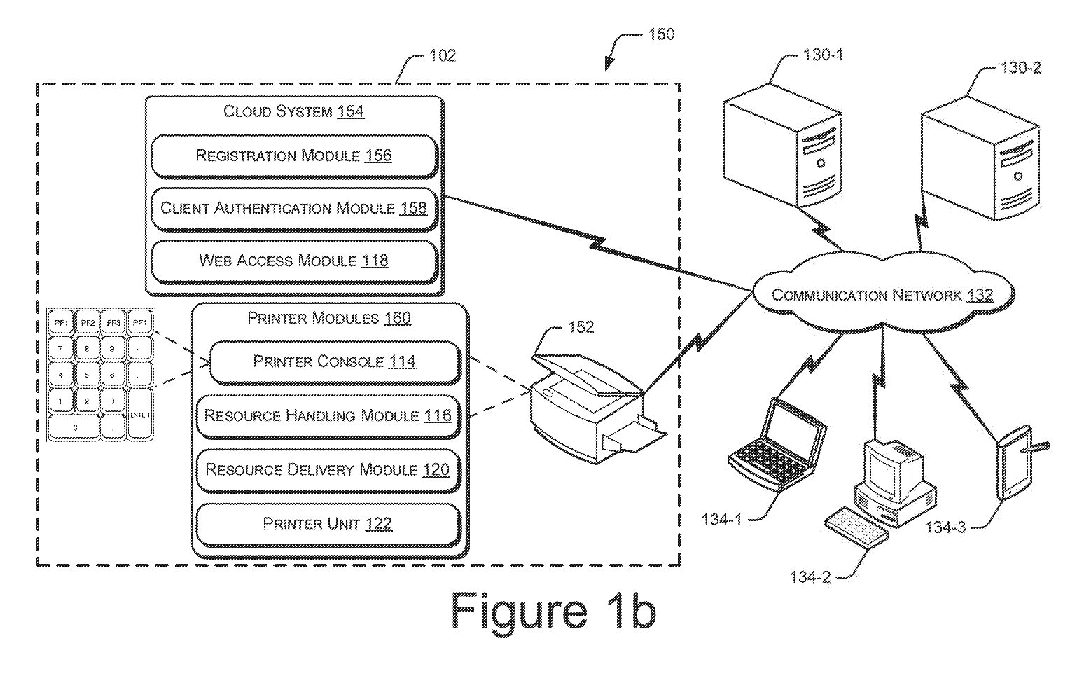

The manner in which the systems and methods for printing with multiple print settings are implemented shall be explained in details with respect to FIGS. 1a, 1b, 2, 3 and 4. While aspects of described systems and methods for printing a document over a network can be implemented in any number of different computing systems, environments, and/or configurations, the examples and implementations are described in the context of the following system(s).

FIG. 1a schematically illustrates the components of a network based printing environment 100, according to an example of the present subject matter. In one implementation, the network based printing environment 100 comprises a printing system 102. The printing system 102 may be implemented as various commercially available printers, such as a laser printer, a multi function printer, and an inkjet printer.

In one implementation, the printing system 102 includes a processor 104, and a memory 106 connected to the processor 104. The processor 104 may include microprocessors, microcomputers, microcontrollers, digital signal processors, central processing units, state machines, logic circuitries and/or any other devices that manipulate signals and data based on computer-readable instructions. Among other capabilities, the processor 104 may fetch and execute computer-readable instructions stored in the memory 106.

Functions of the various elements shown in the figures, including any functional blocks labeled as “processor(s)”, may be provided through the use of dedicated hardware as well as hardware capable of executing computer-readable instructions.

The memory 106, communicatively coupled to the processor 104, can include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

Further the printing system 102 includes interfaces 108. The interfaces 108 may include a variety of commercially available interfaces, for example, interfaces for peripheral device(s), such as data input output devices, referred to as I/O devices, storage devices, network device. The I/O device(s) may include Universal Serial Bus (USB) ports, Ethernet ports, host bus adaptors, and their corresponding device drivers. The interface(s) 108 facilitate the communication of the printing system 102 with various communication and computing devices and various communication networks, such as networks that use a variety of protocols, for example, Hypertext Transfer Protocol (HTTP) and Transmission Control Protocol/Internet Protocol (TCP/IP).

Further, the printing system 102 may include module(s) 110. The modules 110 may be coupled to the processors 104. The modules 110, amongst other things, include routines, programs, objects, components, data structures, which perform particular tasks or implement particular abstract data types. The modules 110 may also be implemented as, signal processor(s), state machine(s), logic circuitries, and/or any other device or component that manipulate signals based on computer-readable instructions.

In said implementation, the module(s) 110 includes a printer console 114, a resource handling module 116, a web access module 118, a resource deliver module 120, a printer unit 122 and other module(s) 124. The other module(s) 124 may include computer-readable instructions that supplement applications or functions performed by the printing system 102.

Further, the printing system 102 may also include data 112. In one implementation, the data 112 includes print jobs data 126 and other data 128. The other data 128 may include data generated and saved by the modules 110 for providing various functionalities of the printing system 102.

In operation, a user may press any button on a keypad or touch an icon on a user interface generated by the printer console 114 to indicate that a document is to be printed. In response to the user's indication, the printer console 114 may generate a user interface prompting the user to enter the URI of the document. The URI may be in form of a uniform resource locator (URL) of a webpage located on a web server 130-1, a file server protocol (FTP) server address 130-2, and so on. In one example, the user may use a scanning module (not shown in figure) of the printing system 102 to scan a handwritten or printed copy of the URI of the document. The printer console 114 may implement techniques, such as optical character recognition, to identify the URI from the scanned document. In one example, the printer console 114 may provide the user with an option to edit and confirm the identified URI. In another scenario, the user may key in the URI of the document using the keypad of the printing system 102. In certain cases, the document indicated by the URI may be protected from unauthorized access. In such a scenario, the user may also provide the authentication details, such as a username and a password, for accessing the document. Further, the user may also provide instructions on whether he wants to be notified whenever the print job is ready for execution.

The user further indicates, using the user interface generated by the printer console 114, various print parameters pertaining to the print job. For example, the print parameters may indicate the time at which the print job is to be executed, whether the print job is a recurring job which is to be executed at fixed or regular time intervals and so on.

In one example, the printer console 114 prompts the user to input a claim code corresponding to the printing instructions. The claim code is to be used as a password to validate the user at the time of providing the output. The print job details provided by the user may be saved as print jobs data 126. In one implementation, the user or other users may access the saved print jobs for reuse.

The resource handling module 116 of the printing system 102 may then verify the availability of resources to execute the print job. In one implementation, the resource handling module 116 may use various network operations such as ping a network resource, such as a gateway, a web server and a domain name service (DNS) server to ascertain connectivity to the internet. Further, the resource handling module 116 may ascertain the availability of the media on which the document if to be printed, availability of ink and so on. If the resource handling module 116 confirms the availability of resources, the resource handling module 116 may notify the user, using the printer console 114, that the print job has been accepted and will be processed. In case, the resource handling module 116 ascertains at least one of the resources to be unavailable because of which the print job cannot be executed, the resource handling module 116 may alert the user of the same by generating an error message.

As per the schedule of the print job, the web access module 118 may access a server, such as the web server 130-1 and the FTP server address 130-2, in which the document is loaded, and download the document identified by the URI over the internet. In case, the document is protected from unauthorized access, the web access module 118 may use the authentication details provided by the user to access the document. In one implementation, the web access module 118 may access the server over a communication network 132. The communication network 132 may include Global System for Mobile Communication (GSM) network, Universal Mobile Telecommunications System (UMTS) network, or any of the commonly used public communication networks that use any of the commonly used protocols, for example, Hypertext Transfer Protocol (HTTP) and Transmission Control Protocol/Internet Protocol (TCP/IP).

On successful downloading of the document, based on user instructions to receive notifications, the resource delivery module 120 may notify the user, for example through e-mail, that the user's print job is ready for execution. In one example, the resource delivery module 120 may send a message using short message service (SMS) gateway or a notification to the users device, such as a laptop 134-1, a workstation 134-2 ad a mobile phone 134-3.

The resource delivery module 120 may then pass instructions to the printer console 114 to generate a user interface prompting the user to enter the claim code for verification. The resource delivery module 120 verifies if the entered claim code matches the claim code entered earlier by the user. If the claim codes are a match, then the printer unit 122 prints the document and the user is provided with a hard copy of the document. In case, the claim codes do not match, the resource delivery module 120 may then pass instructions to the printer console 114 to generate an error message for the user and may prompt the user to re-enter the claim code.

Thus, the printing system 102 facilitates printing of a document over a network without the user having to log on to a host system for accessing the document. The printing system 102 further facilitates the user to print a dynamically changing document at regular time intervals. Hence, the printing system 102 provides for a fast and easy method for printing documents available on the internet.

FIG. 1b schematically illustrates the components of a printing system 102 in a cloud environment 150, according to an example of the present subject matter. In one implementation, the printing system 102 in the cloud environment 150 includes a printer 152 and a cloud system 154. The cloud system 154 may be implemented as various commercially available computing systems, such as a desktop, a workstation, a server and a network server.

In one example, the cloud system 154 may include a processor, such as the processor 104, a memory coupled to the processor 104 and various modules which are coupled to the processor 104. In one example, the cloud system 154 includes a registration module 156, a client authentication module 158 and the web access module 118.

In said example, the printer 152 may include a processor (not shown in the figure) and various printer modules 160 coupled to the processor. In one implementation, the printer modules 160 include the printer console 114. the resource handling module 116, the resource delivery module 120 and the printer unit 122.

In operation, a user may touch an icon on a user interface generated by the printer console 114 to indicate that a document is to be printed. The printer console 114 may prompt the user to enter the URI of the document and the authentication details to access the document. The user may also provide various print parameters pertaining to the print job. The print console 114 may also the user to input the claim code corresponding to the printing instructions.

The resource handling module 116 of the printing system 102 may then verify the availability of resources to execute the print job. On confirming the availability of resources, the resource handling module 116 may notify the user, using the printer console 114, that the print job has been accepted and will be processed.

In one implementation, the resource handling module 116 generates a print job which is to be transmitted to the cloud system 154. The print job may include various parameters, such as the URI of the document, the authentication details to access and download the document and the identity of the printer 152. The resource handling module 116 then transmits the generated print job over the communication network 132 to a cloud system 154.

In said implementation, the registration module 156 of the cloud system 154 may receive the print job from the printer 152 in various formats, such as an extensible markup language (XML) file. The registration module 156 may also identify various printers connected to the communication network 132 with the cloud system 154. In one implementation, the client authentication module 158 may verify the authenticity of a printer connected to the communication network 132 before the printer is registered with the cloud system 154. In various examples, the authentication of the printers may be done through printer name, network address, username and password combination and so on. Further, the registration module 156 may also obtain the specifications of the printer 152, such as the speed of printing, maximum size of attachments supported, maximum number of attachments supported and time during which the printer 152 is online, i.e., available for printing.

The registration module 156 may also parse the received print job to determine the URI of the document, the authentication details, if any, to access the document and the identity of the printer 152 from which the print job has been received. Based on the parsing, the web access module 118 may download the document over the internet. In certain cases, the web access module 118 may also provide the authentication details to the server storing the document to gain access to and download the document. The web access module 118 then transmits the document to the printer 152 over the cloud network implemented by the cloud system 154 and the communication network 132.

In one implementation, the resource delivery module 120 receives the downloaded document and transmits the received document to the printer unit 122 for printing. On completion of printing the resource delivery module 120 may provide the user with the printed copy of the document. In one implementation, the resource delivery module 120 may request the user to provide a claim code to verify the user and may provide the user with a printed copy of the document on verifying the user.

Thus, the printing system 102 further facilitates the user to print a dynamically changing document at regular time intervals. Hence, the printing system 102 provides for a fast and easy method for printing documents available on the internet.

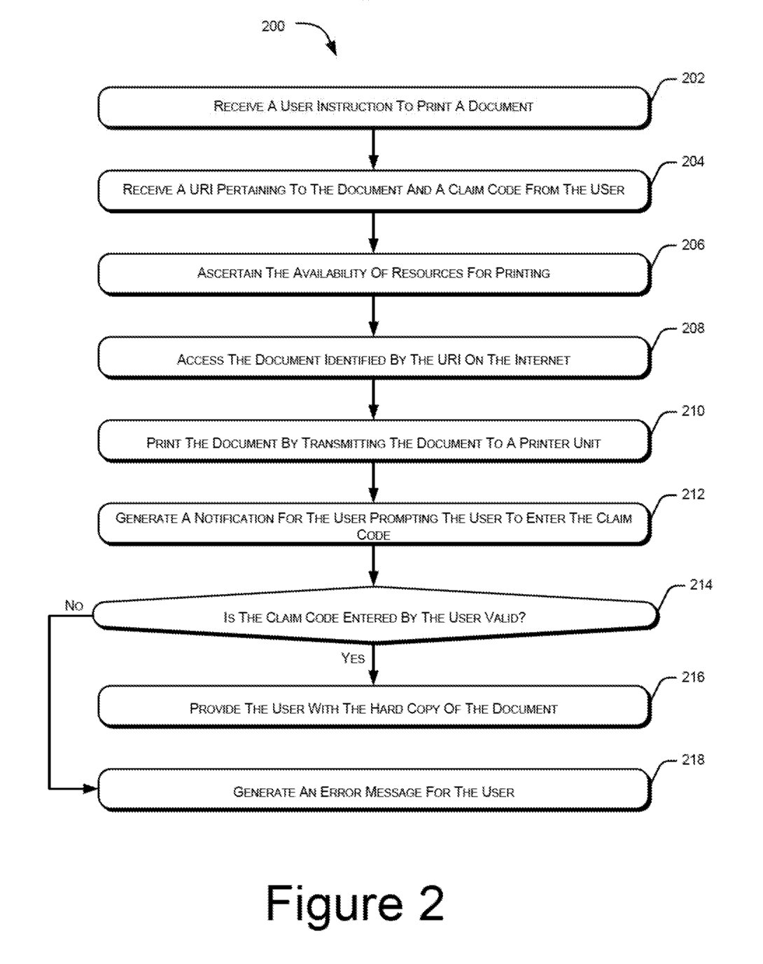

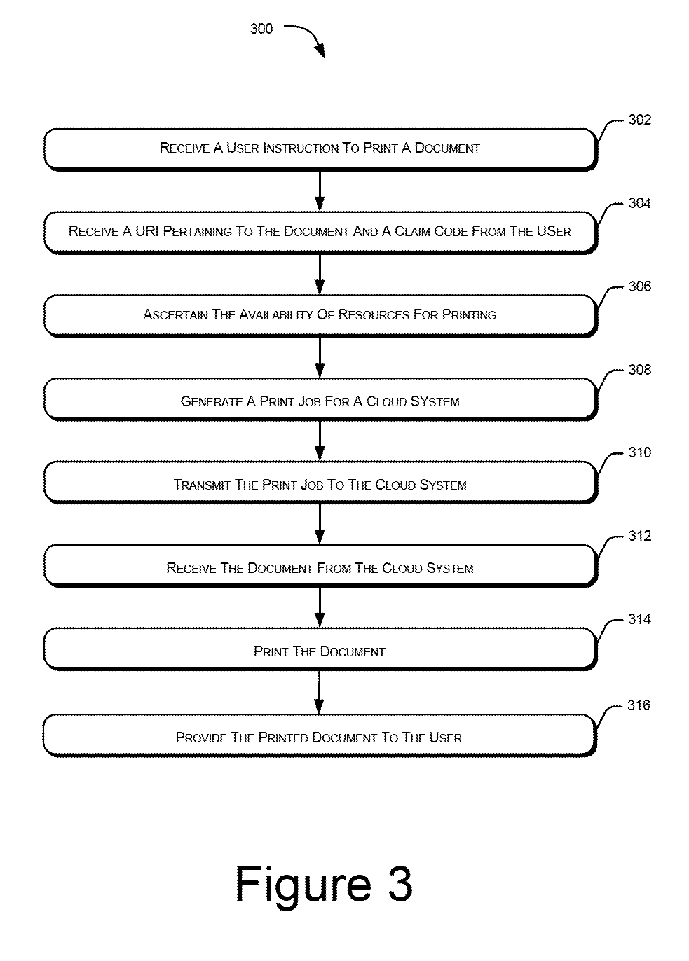

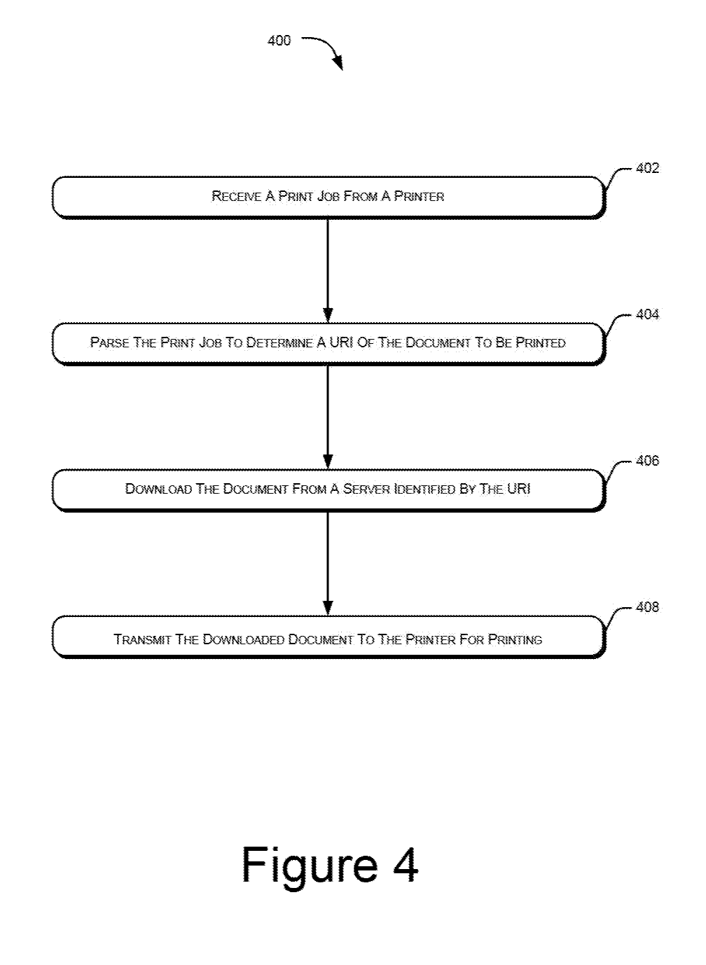

FIG. 2 illustrates a method 200 for printing a document over a network, according to an example of the present subject matter, whereas FIGS. 3 and 4 illustrate methods 300 and 400 respectively for printing a document in a cloud environment, according to examples of the present subject matter. The order in which the methods 200, 300 and 400 are described is not intended to be construed as a limitation, and any number of the described method blocks can be combined in any order to implement methods 200, 300 and 400, or an alternative method. Additionally, individual blocks may be deleted from the methods 200, 300 and 400 without departing from the spirit and scope of the subject matter described herein. Furthermore, the methods 200, 300 and 400 may be implemented in any suitable hardware, machine readable instructions, firmware, or combination thereat

A person skilled in the art will readily recognize that steps of the methods 200, 300 and 400 can be performed by programmed computers. Herein, some examples are also intended to cover program storage devices, for example, digital data storage media, which are machine or computer readable and encode machine-executable or computer-executable programs of instructions, where said instructions perform some or all of the steps of the described methods 200, 300 and 400. The program storage devices may be, for example, digital memories, magnetic storage media such as a magnetic disks and magnetic tapes, hard drives, or optically readable digital data storage media.

With reference to method 200 as depicted in FIG. 2, as depicted in block 202, user instructions to print a document are received. In one implementation, the user may indicate that a document is to be printed by pressing any button on the keypad of the printing system 102 or by touching an icon on the user interface generated by the printer console 114.

As illustrated in block 204, the URI pertaining to the document is received from the user. Additionally, the user provides a claim code for the print job. In one implementation, the user may scan a document on which the URI of the document is written by hand or is printed. In another example, the user may key in the URI of the document using the keypad of the printing system 102. Further, the user interface generated by the printer console 114 may prompt the user to enter a claim code for the print job. The claim code may be used to validate the user at the time of execution of the print job.

As shown at block 206, the availability of resources for executing the print job, i.e., printing the document, is ascertained. In one implementation, the resource handling module 116 may use various network operations such as pinging a network resource, for example a gateway, a web server and a domain name service (DNS) server to ensure connectivity to the internet. The resource handling module 116 may also check the availability of the media on which the document is to be printed, the availability of ink and so on. On confirming the availability of resources, the resource handling module 116 may notify the user, using the printer console 114.

At block 208, the document identified by the URI is accessed and downloaded. In one implementation, the web access module 118 may access the server in which the document is located over the internet or a communication network. The web access module 118 downloads the document from the server into the memory of the printing system 102. In one implementation, the document may temporarily be saved as print jobs data 126.

As illustrated in block 210, the downloaded document is printed. In one implementation, the web access module 118 transmits the document to the printer unit 122 for printing with the requisite print settings.

As depicted in block 212, a notification is generated for prompting the user to enter a claim code for the print job. In one implementation, the resource delivery module 120 notifies the user that the user's print job is ready for execution. Further, the resource delivery module 120 may transmit instructions for the printer console 114 to generate a user interface prompting the user to enter the claim code for verification.

As shown in block 214, it is verified whether the claim code as entered by the user matched the claim code entered earlier by the user. In one implementation, the resource delivery module 120 verifies whether the entered claim code matches the earlier claim code entered by the user.

If at block 214, it is verified that the claim code as entered by the user matches the claim code entered earlier by the user, then as depicted at block 216 the user is provided with the hard copy of the document.

If at block 214, it is verified that the claim code as entered by the user does not match the claim code entered earlier by the user, then as depicted at block 218 an error message is generated for the user. In such a case, the resource delivery module 120 may transmit instructions for the printer console 114 to generate the error message.

Thus, the method 200 facilitates printing of a document over a network without the user having to log on to a host system for accessing the document over the internet.

With reference to method 300 as depicted in FIG. 3, as depicted in block 302, user instructions to print a document is received. In one implementation, the user may indicate that a document is to be printed by pressing any button on the keypad of the printer 152 or by touching an icon on the user interface generated by the printer console 114.

As illustrated in block 304, the URI pertaining to the document is received from the user. Additionally, the user provides a claim code for the print job. In one implementation, the user may scan a document on which the URI of the document is written by hand or is printed or key in the URI of the document using the keypad of the printer 152. Further, the user interface generated by the printer console 114 may prompt the user to enter a claim code for the print job. Further, in case, the document indicated by the URI is protected from unauthorized access, the user may also provide the authentication details to access the document.

As shown at block 306, the availability of resources for executing the print job, i.e., printing the document, is ascertained. In one implementation, the resource handling module 116 may, for example, ensure connectivity to the Internet. The resource handling module 116 may also check the availability of resources for printing. On confirming the availability of resources, the resource handling module 116 may notify the user, using the printer console 114.

As depicted in block 308, a print job may be generated for the cloud system 154. In one implementation, the resource handling module 116 may generate a print job. The print job may include various parameters, such as the URI of the document, the authentication details to access and download the document and the identity of the printer 152. The identity of the printer 152 may be a printer name, an Internet protocol (IP) address of the printer and so on.

As illustrated in block 310, the generated print job is transmitted to the cloud system 154. In one implementation, the resource handling module 116 may transmit the generated print job over the communication network 132 to a cloud system 154.

At block 312, the document to be printed is received from the cloud system 154. In one example, the document may be received by the resource delivery module 120. The received document may be various file formats, such as a portable format document (PDF) file, a word document, a spreadsheet and a hypertext markup language (HTML) file.

As depicted in block 314, the document is printed. In one implementation, the resource delivery module 120 transmits the received document to the printer unit 122 for printing.

As illustrated in block 316, the printed document is provided to the user. In one example, the resource delivery module 120 may request the user to provide a claim code to verify the user and may provide the user with a printed copy of the document on verifying the user.

Thus, the method 300 facilitates printing of a document over a network without the user having to log on to a host system for accessing the document over the internet.

With reference to method 400 as depicted in FIG. 4, as depicted in block 402, a print job is received from a printer, such as the printer 152. In one implementation, the registration module 156 of the cloud system 154 may receive the print job from the printer 152 in various formats, such as an extensible markup language (XML) file.

As illustrated in block 404, the print job is parsed to determine the URI of the document to be printed. In one example, the registration module 156 may parse the received print job to determine the URI of the document, the authentication details, if any, to access the document, the identity of the printer 152 from which the print job has been received and so on.

As shown in block 406, the document identified by the URI is downloaded. In one implementation, the web access module 118 may download the document over the Internet. In certain cases, the web access module 118 may provide the authentication details to the server storing the document to gain access to and download the document.

At block 408, the downloaded document is transmitted to the printer for printing. In one implementation, the web access module 118 may transmit the document to the printer 152 over the cloud network implemented by the cloud system 154 and the communication network 132.

Although implementations for printing a document over a network have been described in language specific to structural features and/or methods, it is to be understood that the appended claims are not necessarily limited to the specific features or methods described. Rather, the specific features and methods are disclosed as examples of systems and methods printing a document over a network.

I/we claim:

1. A printing system (102) for printing a document over a network, the printing system (102) comprising:
a processor (104); and
a printer console (114) coupled to the processor(104), to receive a print job from a user, the print job comprising a unique resource identifier (URI) of a document which is to be printed and print parameters associated with the print job:
a web access module (118) coupled to the processor(104), to download the document over the network; and
a printer unit (122) coupled to the processor(104), to print the document based on the print parameters.

2. The printing system (100) as claimed in claim 1, further comprising a resource delivery module (120), coupled to the processor (104), to generate a notification for the user on completion of printing the document.

3. The printing system (100) as claimed in claim 1 wherein the resource delivery module (120) further:
receives a claim code from the user;
verifies the claim code received; and
delivers a hard copy of the document o the user on successful verification.

4. The printing system (100) as claimed in claim 1, wherein the printer console further,
scans a document on which the URI is at least one of handwritten and printed;
analyzes the document to identify the URI; and
transmits the URI to the web access module (118) for downloading the document.

5. The printing system (100) as claimed in claim 1, further comprising a resource handling module (116), coupled to the processor (104), to ascertain availability of resources for printing the document.

6. A method for printing a document over a network, the method comprising:
receiving, a print job from a user, the print job comprising a unique resource identifier (URI) of a document which is to be printed and print parameters associated with the print job;
transmitting the print job to a cloud system (154) for downloading the document over a communication network (132);
receiving the downloaded document over the communication network (132); and
printing the downloaded document based on the print parameters.

7. The method as claimed in claim 6, the method further comprising:
parsing the print job to determine at least one of a unique resource identifier (URI) of the document which is to be printed and authentication details for accessing the document which is to be printed; and
downloading the document based on the parsing.

8. The method as claimed in claim 6, the method further comprising analyzing the print parameters to determine at least one of whether the print job is a recurring job to be executed at regular intervals and a time of execution of the print job.

9. The method as claimed in claim 6, the method further comprising generate a notification for the user on completion of printing the document.

10. The method as claimed in claim 6, the method further comprising:
generating a notification prompting the user to enter a claim code;
receiving a claim code from the user;
verifying the claim code received; and
delivering a hard copy of the document to the user on successful verification.

11. The method as claimed in claim 6, the method further comprising:
scanning a document on which the URI is at least one of handwritten and printed;
analyzing the document to identify the URI; and
transmitting the URI for downloading the document.

12. A non-transitory computer-readable medium having a set of computer readable instructions that, when executed, cause a printing system to:
generate an user interface to receive a print job from a user;
receive a print job from a user, the print job comprising a unique resource identifier (URI) of a document which is to be printed, a claim code for verification of the user at the time of execution of the print job and print parameters associated with the print job;
ascertain availability of resources for printing the document;
analyze the print parameters to determine at least one of whether the print job is a recurring job to be executed at regular intervals and a time of execution of the print job
download the document over the network based on the ascertaining; and
print the document based on the analysis of the print parameters.

13. The non-transitory computer-readable medium as claimed in claim 12, wherein the instructions executed further cause the printing system to:
scan a document on which the URI is at least one of handwritten and printed;
analyze, using optical character recognition, the document to identify the URI; and
transmit the URI for downloading the document

14. A cloud system (154) for printing a document over a network, the cloud system (154) comprising:
a processor;
a registration module (156) coupled to the processor, to
receive a print job from a printer (152) over a communication network (132);
parse the received print job to determine at least one of a unique resource identifier (URI) of a document to be printed, the authentication details to access the document to be printed and the identity of the printer 152 from which the print job has been received;
a web access module (118) coupled to the processor, to:
download the document to be printed over the communication network (132); and
transmit the downloaded document to the printer 152, over the communication network (132), for printing.
